(19) United States
(12) Patent Application Publication
(10) Pub. No.: US 2026/0134269 A1
(43) Pub. Date: May 14, 2026

(54) SYSTEMS AND METHODS FOR TRAINING SPIKING NEURAL NETWORKS

(71) Applicant: Ohio State Innovation Foundation, Columbus, OH (US)

(72) Inventors: Anthony Baietto, Columbus, OH (US); Trevor Bihl, Columbus, OH (US); Christopher Stewart, Columbus, OH (US)

(21) Appl. No.: 19/385,624

(22) Filed: Nov. 11, 2025

Related U.S. Application Data
(60) Provisional application No. 63/718,921, filed on Nov. 11, 2024.

(51) Int. Cl. G06N 3/049; G06N 3/045

(52) U.S. Cl. CPC G06N 3/049; G06N 3/045

(57) ABSTRACT

An example computer-implemented method for training a spiking neural network, includes receiving a neuromorphic dataset; training, using the neuromorphic dataset, a spiking conditional generative adversarial network to model a distribution of the neuromorphic dataset; generating a plurality of synthetic neuromorphic samples by the trained spiking conditional generative adversarial network; selecting a subset of the plurality of synthetic neuromorphic samples based on at least one quality metric; and training a spiking neural network using the subset of the plurality of synthetic neuromorphic samples.

### CROSS-REFERENCE TO RELATED APPLICATIONS

This application claims the benefit of U.S. provisional patent application No. 63/718,921, filed on Nov. 11, 2024, and titled “SYSTEMS AND METHODS FOR TRAINING NEURAL NETWORKS,” the disclosure of which is expressly incorporated herein by reference in its entirety.

### STATEMENT REGARDING FEDERALLY FUNDED RESEARCH

This invention was made with government support under FA8650-21-C-1174 awarded by the US Air Force Research Labs. The government has certain rights in the invention.

### BACKGROUND

Spiking neural networks model the behavior of biological neurons. In a spiking neural network, the timing of discrete spikes can define the information exchanged between neurons. Spiking neural networks may not continuously exchange information between neurons (e.g., during continuous propagation cycles). Instead, spiking neural networks may exchange information only when an artificial neuron of the network fires. Improvements to spiking neural network training can improve spiking neural networks.

### SUMMARY

In some aspects, implementations of the present disclosure include a computer-implemented method for training a spiking neural network, the computer-implemented method including: receiving a neuromorphic dataset; training, using the neuromorphic dataset, a spiking conditional generative adversarial network to model a distribution of the neuromorphic dataset; generating a plurality of synthetic neuromorphic samples by the trained spiking conditional generative adversarial network; selecting a subset of the plurality of synthetic neuromorphic samples based on at least one quality metric; and training a spiking neural network using the subset of the plurality of synthetic neuromorphic samples.

In some aspects, implementations of the present disclosure include a computer-implemented method, wherein the neuromorphic dataset includes neuromorphic image data.

In some aspects, implementations of the present disclosure include a computer-implemented method, wherein the neuromorphic image data includes a plurality of images corresponding to different lighting conditions.

In some aspects, implementations of the present disclosure include a computer-implemented method, wherein the quality metric includes a similarity of the synthetic neuromorphic samples and the neuromorphic dataset.

In some aspects, implementations of the present disclosure include a computer-implemented method, wherein the quality metric includes a frame difference metric.

In some aspects, implementations of the present disclosure include a computer-implemented method, wherein the frame difference metric includes a cosine similarity of successive pairs of quantized frames.

In some aspects, implementations of the present disclosure include a computer-implemented method, wherein the quality metric includes a sparsity metric.

In some aspects, implementations of the present disclosure include a computer-implemented method, wherein the sparsity metric includes an average number of events per pixel of an image.

In some aspects, implementations of the present disclosure include a computer-implemented method, wherein the quality metric includes a density metric.

In some aspects, implementations of the present disclosure include a computer-implemented method, wherein the density metric includes an average number of events per frame.

In some aspects, implementations of the present disclosure include a computer-implemented method, wherein the spiking neural network is further trained on the neuromorphic dataset.

In some aspects, implementations of the present disclosure include a computer-implemented method, wherein the generative adversarial network is further trained on a source of latent noise.

In some aspects, implementations of the present disclosure include a computer-implemented method including: training a SNN classifier to obtain a trained SNN classifier by receiving a neuromorphic dataset; training, using the neuromorphic dataset, a spiking conditional generative adversarial network to model a distribution of the neuromorphic dataset; generating a plurality of synthetic neuromorphic samples by the trained spiking conditional generative adversarial network; selecting a subset of the plurality of synthetic neuromorphic samples based on at least one quality metric; and training a spiking neural network using the subset of the plurality of synthetic neuromorphic samples; receiving a neuromorphic sensor output from a neuromorphic sensor; inputting the neuromorphic sensor output into the trained SNN classifier; and receiving, from the trained SNN classifier, a classification of the neuromorphic sensor output.

In some aspects, implementations of the present disclosure include a computer-implemented method, wherein the quality metric includes at least one of a sparsity metric, a frame difference metric, or a similarity metric.

In some aspects, implementations of the present disclosure include a computer-implemented method, wherein the trained SNN classifier is further trained on the neuromorphic dataset.

In some aspects, implementations of the present disclosure include a computer-implemented method, further wherein the neuromorphic sensor output includes a neuromorphic image captured by a dynamic vision sensor.

In some aspects, implementations of the present disclosure include a system for image classification, the system including: a dynamic vision sensor configured to acquire neuromorphic data; a computing device operatively coupled with the dynamic vision sensor, the computing device including a processor and memory with instructions stored thereon, that, when executed by the processor, cause the processor to: receive a trained SNN classifier, wherein the trained SNN classifier is trained using a synthetic neuromorphic dataset; receive the neuromorphic data from the dynamic vision sensor; input the neuromorphic data into the trained SNN classifier; and receive, from the trained SNN classifier, a classification of the neuromorphic data; and output the classification.

In some aspects, implementations of the present disclosure include a system, wherein the SNN classifier is trained using a neuromorphic dataset and a plurality of synthetic neuromorphic samples generated by a CGAN.

In some aspects, implementations of the present disclosure include a system, wherein the processor is a neuromorphic processor.

In some aspects, implementations of the present disclosure include a system, wherein the processor is further configured to segment the neuromorphic data into a plurality of fixed-time-width bins.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a flow chart of an example method for training a spiking neural network, according to implementations of the present disclosure.

FIG. 1B illustrates an example method of using the spiking neural network trained according to FIG. 1A, according to implementations of the present disclosure.

FIG. 2 illustrates an example system for neuromorphic computing, according to implementations of the present disclosure.

FIG. 3 is an example computing device.

FIG. 4 illustrates example quality metrics on an example dataset, according to implementations of the present disclosure.

FIG. 5 illustrates an example comparison of real and synthetic data, according to a study of an example implementation of the present disclosure.

FIG. 6 illustrates the impact on test accuracy for expanding the DVSGesture dataset, according to a study of an example implementation of the present disclosure.

FIG. 7A illustrates an example classifier and discriminator architecture for an example implementation of the present disclosure.

FIG. 7B illustrates an example generator architecture for an example implementation of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for training spiking neural networks with particular types of neuromorphic data, it will become evident to those skilled in the art that the implementations are not limited thereto, but are applicable for any type of neuromorphic data and for different architecture of spiking neural networks.

Traditional sensors, such as cameras, are disconnected from artificial neural network (ANN) computation because data must be first captured, processed, and then finally computed on where each of these steps incurs additional power consumption. Data capture using frame-based cameras must collect the entire frame at each snapshot even if there is little change between frames, a growing problem as computation is moving towards more temporal processing as opposed to static. This captured data is then often pre-processed with a number of transformations including rotations, filtering, and scaling, on hardware separate from both the capture device and the ANN. Finally, the processed data must be sent to the ANN where it can be computed on. These individualized steps drastically slow down ANN training and inference as well as increase total power consumption.

Neuromorphic computing, based on the properties of biological neurons, promises to overcome limitations of these conventional steps. Unlike conventional AI computing which operates on function approximation using linear algebra, neuromorphic computing operates on the principle of discrete spikes or pulses of activity, mimicking the asynchronous communication observed in the brain. Spiking Neural Networks (SNNs) are a neuromorphic alternative to layered feed-forward ANNs. SNNs utilize neurons that encapsulate the complex spiking behavior of biological neurons. This new approach not only facilitates efficient temporal processing but also offers potential advantages in energy efficiency and resilience to noisy inputs without sacrificing computation abilities. When realized on specialized neuromorphic hardware, for example, using hardware trade named Loihi and Loihi 2, the individual neuron-to-neuron communication can be fully exploited to achieve sub-Watt processing.

Coupled with neurocomputing are neuromorphic sensors, data capturing devices which operate on localized changes as opposed to global time-stepping. Dynamic Vision Sensors (DVSs) are a neuromorphic alternative to traditional cameras, utilizing independent pixels which trigger events when there is a change in luminance. These asynchronous events allow neuromorphic sensors to circumvent the physical limitations of conventional frame-based sensors, such as the high number of frames needed to capture temporal data. DVSs exhibit superior power efficiency compared to conventional frame-based cameras since they only produce output when there is a significant change in luminance. Additionally, this event-driven approach drastically reduces the amount of data that needs to be processed, transmitted, and stored, allowing for direct computation by SNNs. Neuromorphic sensors coupled with neuromorphic computing can open a new chapter for real-time and low-power edge computing.

Generative Adversarial Networks. Most ANN models are classifiers which attempt to categorize the input data by assigning a label based on the most likely class. These classifiers however can only describe a distribution of data, they cannot draw from that distribution to create new data. Generative models are a special branch of ANNs which can sample from a learned data distribution and create artificial samples which appear to have come from the original distribution. An example of these models are Generative Adversarial Networks (GANs) which use both a classifying model, to learn a data distribution, and a generative model, to draw from said distribution, in tandem. The generative model G attempts to produce realistic samples i.e., appearing to have come from the original distribution, while the discriminator model D classifies samples as either coming from the real distribution or as fake samples generated by G. These two models are trained in an alternating fashion so that as D becomes better at spotting the differences between the two distributions, its gradients are used to improve G at mirroring the target distribution. Given a real data distribution p_{data} and a latent space p_{z}, this process can be represented as

$${min}_{G} {max}_{D} V ( D , G ) = {x ∼ {p}_{data} ( x )}_{} [ log ( D ( x ) ) ] + {z ∼ {p}_{z} ( z )}_{} [ log ( 1 - D ( G ( z ) ) ) ]$$

with convergence point p_{g}≈p_{data} and D(x)=0.5 where G has satisfactorily approximated the data distribution and D is unable to distinguish between real and generated samples. An extension to the GAN architecture is the Conditional GAN (CGAN), which includes an input label to both G and D such that arbitrary samples of a specific class, as opposed to random, can be generated.

The GAN framework is an effective tool for emulating a data distribution via the generation of realistic samples. Recent works have combined the GAN framework and neuromorphic processing with various tradeoffs. Such works include a SNN generator with a traditional ANN discriminator to backpropagate differences between binary vectors using a temporally compressed embedding of the data. Another example uses SNNs for both the generator and the discriminator to generate images using Time-To-First-Spike (TTFS) encoding where each pixel value is represented by the time the corresponding neuron fires. A full end-to-end spiking GAN framework was proposed for generating CIFAR-10 spike trains, however, CIFAR-10 is not a native neuromorphic dataset which introduces integration issues with neuromorphic processing.

Spiking Neural Networks (SNNs) are the next generation of biologically plausible Artificial Neural Networks (ANNs) which utilize neurons that communicate via binary spikes distributed over time rather than scalar values. These sparse neuron-to-neuron communications offer significant power savings when realized on purpose-built neuromorphic hardware. However, training SNNs is challenging because backpropagation, the conventional technique used for ANNs, cannot handle the discrete pulses spread across differing neurons during activation. Various SNN training platforms have been put forth that provide workarounds for this problem by loosening the constraints on neuron activation. Such approximations have the negative side-effect of forming dependencies to the specific viewpoint in which the training spike data was collected. A distinction between ANNs and SNNs is the type of training mechanism that can be used. Because ANNs utilize differentiable activation functions, backpropagation via gradient-descent can be employed to update the weighted connections between neurons. However, the spiking mechanism behind neuromorphic processing is nondifferentiable, and so conventional training methods cannot be directly applied. Multiple workarounds exist for circumventing this issue, one of which relaxes the constraints surrounding a spiking neuron to achieve a differentiable approximation. SLAYER (Shrestha & Orchard, 2018), a popular PyTorch-based framework, uses a probability-backed approximation of the spiking activation function. Rather than the simplistic LIF model, the Spike Response Model (SRM) is used to model the membrane voltage as a linear sum of postsynaptic potentials. Given a refractory kernel η, the neuron's response to an outgoing spike, and linear filter κ, the contribution of each spike to the input current, the membrane voltage is modeled as

$$V ( t ) = {\sum }_{f} η ( t - {t}^{f} ) + {\int }_{0}^{∞} κ ( s ) I ( t - s ) ds + {V}_{rest}$$

for each spike f occurring at time t^{f}.

Moreover, the temporal nature of SNNs combined with their non-differentiable neuron activations leads to hidden dependencies within the model on the specific viewpoint in which the data were collected. Samples may record identical high-level information, such as a subject performing the same action in the case of the DVSGesture dataset; however, the samples can differ temporally in the distribution of spikes throughout the presentation time. Such differences in the spike distribution stem from the viewpoint in which the data were collected e.g., lighting conditions and DVS camera settings. Mechanistic models used in conventional SNN platforms perform poorly when presented with samples of differing spike viewpoints caused by changes in light intensity, simulation parameters, or Dynamic Vision Sensor (DVS) camera settings.

The present disclosure addresses these and other limitations of the art by disclosing systems and methods for training and validating neuromorphic data, training spiking neural networks using synthetic neuromorphic data, and using the disclosed trained models for image classification. Implementations of the present disclosure include a platform-agnostic approach for dataset assembly, the maximization of model potential through methodical dataset selection at the sample-level granularity. The implementation of the present disclosure mitigates spike viewpoint dependencies by combining established SNN training approximations with a Generative Adversarial Network (GAN) to augment training datasets with broader spike distribution data. Dataset assembly improves model robustness on targeted viewpoints, without introducing significant computational overhead, by extracting untapped performance from extant starting datasets. Models trained using the example implementation described herein boast a 187.28% increase in accuracy robustness when evaluated on differing spike viewpoints using the IBM DVSGesture dataset.

Implementations of the present disclosure include improvements to training spiking neural networks. Spiking neural networks (SNNs) include limitations on training that can be unique to SNNs. For example, SNNs are susceptible to being trained to closely fit the training data because SNN activation patterns can be very different for small changes in training data. For example, in the case of image data, different lighting conditions for the same image can result in significant differences in neuron firing timings. Additionally, SNNs can require additional training and processing steps to account for the timing of neuron activations.

“Neuromorphic data” as used herein refers to event-based spatiotemporal data from a neuromorphic sensor. Neuromorphic data captures changes instead of frames. As described herein, neuromorphic data's representations of changes in data, instead of complete data frames, allows for sparse computation with reduced data requirements and power.

Neuromorphic Computing represents a groundbreaking approach to computing that draws inspiration from the architecture and functionality of the human brain. Unlike traditional von Neumann computing architectures, which rely on sequential processing and separate memory and processing units, neuromorphic systems aim to emulate the parallelism, efficiency, and adaptability of biological neural networks. At the heart of neuromorphic computing are SNNs, layered feed-forward networks which operate on the principle of discrete spikes or pulses of activity, akin to the firing of neurons in biological brains, as opposed to the mathematical regression models of ANNs. Neurons within SNNs operate asynchronously, only communicating information to downstream neurons when a threshold is met. This event-driven processing enables neuromorphic systems to efficiently process and respond to sensory inputs in real-time, with minimal latency and energy consumption.

Often, the spiking nature of neuromorphic neurons is captured using the Leaky Integrate-and-Fire (LIF) model. Each neuron is represented as a Resistor-Capacitor (RC) circuit. The membrane voltage of neuron V(t) can be modeled as

$${τ}_{m} \frac{dV ( t )}{dt} = - V ( t ) + RI ( t )$$

where τ represents the membrane time constant, R is the membrane resistance, and l(t) is the input current. When the membrane voltage surpasses threshold Vₜₕ, an instantaneous spike of current is transmitted to downstream neurons, and the neuron is prevented from firing again during the refractory period t_{ref}.

Neuromorphic Sensors. Neuromorphic sensors represent a revolutionary approach to sensing, inspired by the biological sensory systems found in nature. These sensors leverage principles from neuroscience and neuromorphic engineering to mimic the functionality of sensory organs, such as the retina or cochlea, in artificial systems. One feature of neuromorphic sensors is their event-based operation, which is fundamentally different from traditional frame-based sensors. Instead of capturing and transmitting entire frames of data at fixed intervals, neuromorphic sensors only respond to changes in the environment, emitting signals or “events” when significant alterations in sensory input occur. This event-driven approach results in highly efficient data transmission, as only relevant information is communicated, leading to reduced power consumption and bandwidth requirements compared to conventional sensors. In the case of computer vision, DVSs are used which output a stream of events of the form (x, y, t, p) signifying that pixel (x, y) had a (p=1 positive, p=0 negative) change in intensity at time t.

For an example 10×10 pixel image change captured by a frame-based sensor, all 100 pixels are communicated, regardless of how many pixels change, e.g.,: (1,10, #000000) (2,10, #000000) . . . (9,10, #000000) (10,10, #000000) (1, 9, #000000) (2, 9, #000000)− . . . (9,9, #000000) (10, 9, #000000): !!!!(1, 2, #000000) (2, 2, #FFFFFF) . . . (9, 2, #FFFFFF) (10, 2, #000000) (1,1, #000000)(2,1, #000000) . . . (9,1, #000000)(10,1, #000000)

For the same example image captured by a neuromorphic sensor, it may be that only 8 pixels change, and therefore 8 events are communicated: (2, 4, −, 1) (2, 2, +, 1) (2, 5, −, 1) (2, 3, +, 1) (9, 4, −, 1) (9, 2, +, 1) (9,5,−,1) (9,3,+,1)

Frame-based cameras capture all pixel data (x, y, pixel-value) at each instance regardless of duplication. DVS cameras only capture pixels (x, y, change, timestep) experiencing a change in intensity, requiring far less data communication.

This data convention allows neuromorphic sensors to exhibit remarkable adaptability and robustness in diverse environments. By emulating the parallel processing capabilities of biological sensory systems, these sensors can process incoming stimuli in real-time and adapt their sensitivity to different environmental conditions. For example, DVSs can detect and track fast-moving objects with high temporal precision, making them ideal for applications in robotics, autonomous vehicles, and surveillance systems. Similarly, neuromorphic auditory sensors can selectively filter out background noise and focus on specific sound sources, enabling accurate speech recognition and localization in noisy environments. The low-power nature of neuromorphic sensors makes them an excellent asset for edge computing. With intrinsic spatiotemporal properties and fewer intermediary steps between data collection and processing, neuromorphic sensors can bridge the extant gap in edge computation. However, access to neuromorphic datasets is limited which poses a challenge for developing robust neurocomputing models. The lack of standardization amongst the neuromorphic data sources along with the unique operation of neuromorphic hardware has resulted in an undersupply of available data that limits training of models for processing neuromorphic data.

The scarcity of quality neuromorphic datasets poses a significant challenge for the wide-spread adoption of neuromorphic processing. The field of neuromorphic computing is relatively nascent compared to traditional computing paradigms, including those for AI, resulting in less time and resources dedicated to the development and curation of large-scale datasets specifically tailored for neuromorphic systems. Furthermore, the unique architecture and operation of neuromorphic hardware, revolving around event-based processing, require datasets that capture the dynamics of spatiotemporal events rather than static data points which poses a challenge given the de facto stationary sensing technologies. Also, the limited standardization and collaboration within the neuromorphic computing community alongside the interdisciplinary nature of neuromorphic computing, which draws from neuroscience, computer science, and engineering, adds complexity to dataset creation as it often involves integrating knowledge from multiple domains.

Implementations of the present disclosure can overcome these and other problems known in the art. For example, implementation of the present disclosure can be used to generate synthetic spiking data that is similar to real world data, and can be used to improve the training of SNNs. The implementations described herein can be used to generate, and/or expand synthetic neuromorphic datasets using a Conditional Generative Adversarial Network (CGAN). The synthetic neuromorphic dataset can be used to augment the original training dataset. The augmentation of the training dataset results in a hardened downstream SNN classifier which can better generalize across samples collected under a variety of scenarios without significant degradation in accuracy.

The present disclosure includes quality metrics configured for the intricacies specific to neuromorphic datasets to train SNNs using high quality synthetic samples that are validated as comparable or equal to their non-synthetic counterparts. Finally, the present disclosure includes a study using the DVSGesture dataset to illustrate the example implementation's ability to generate artificial samples which match the properties found within the original dataset and thereby improve the SNNs disclosed herein.

Deployment of neuromorphic models requires access to quality neuromorphic datasets for training. With an undersupply of available datasets, the widespread adoption of neuromorphic computing is at risk. Manual collection of neuromorphic datasets is a costly endeavor compounded by the larger data requirements of neuromorphic models due to the inclusion of a time domain along with the spatial domains. The example implementation can address this limitation with a generative approach that uses a spiking CGAN to learn an extant neuromorphic dataset in order to expand it with low-cost synthetic samples.

The example implementation can include at least two example stages. The available neuromorphic dataset (real, non-synthetic samples from one or more neuromorphic sensor) is used to train a spiking CGAN. Training progresses until the generator has adequately learned to emulate the distribution of samples found within the starting dataset. Once trained, the generator is used to generate a synthetic dataset extension which is combined with the starting dataset to train a SNN classifier.

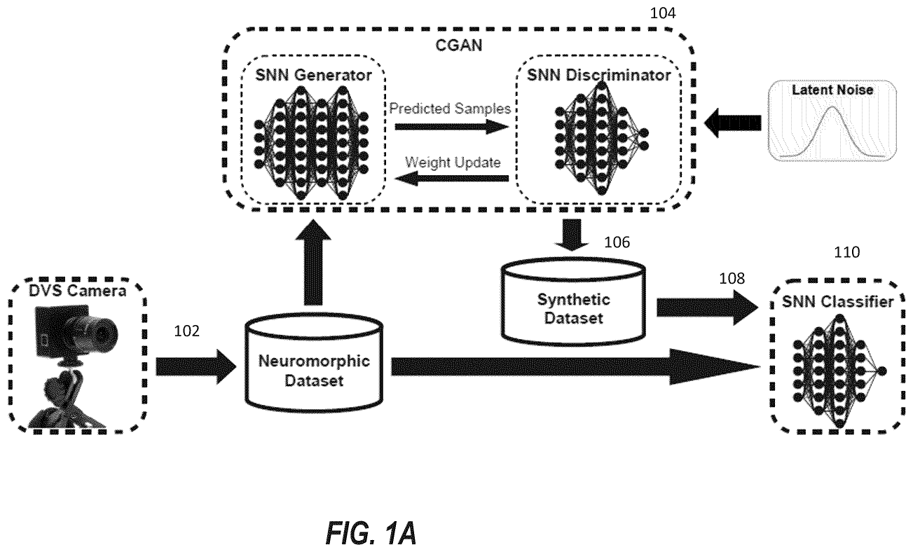

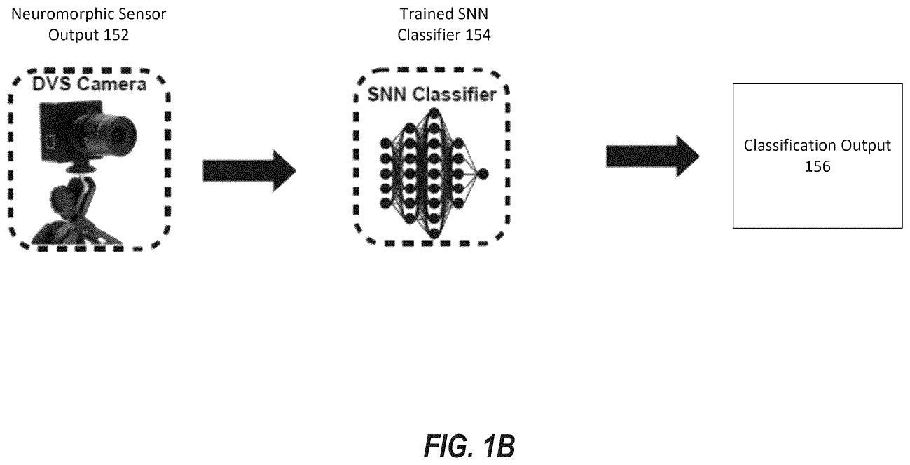

FIG. 1A illustrates an example method that can be used to train spiking neural network classifiers, and to generate synthetic data for training neural network classifiers.

At step 102, the method can include receiving a neuromorphic dataset. The neuromorphic dataset can be acquired from a neuromorphic sensor. An example of a neuromorphic sensor is a dynamic vision sensor (DVS) camera as shown in FIG. 1A, but it should be understood that “neuromorphic cameras” “silicon retinas” and “event cameras” are other neuromorphic sensors that can be used in implementations of the present disclosure. Optionally, the neuromorphic data can include data segmented into a set of fixed-time-width bins.

At step 104, the method includes training a spiking conditional generative adversarial network to model a distribution of the neuromorphic dataset. The GAN architecture can implicitly learn the intricacies of a target dataset and can expertly draw an arbitrary number of generated samples from the learned distribution. The present disclosure can use a spiking CGAN to generate realistic samples of varying spike viewpoints that can be added to training datasets for heightened model robustness. As opposed to manually collecting additional samples for every possible spike viewpoint which can be encountered, a spiking CGAN can efficiently and cheaply generate the necessary samples to expose SNN models during training to a variety of different spike viewpoints. In some implementations, the CGAN at step 104 can be trained on a source of latent noise in addition to the neuromorphic dataset. For example, a latent noise vector can be sampled and concatenated with CGAN inputs.

At step 106, the method includes generating a plurality of synthetic neuromorphic samples by the trained spiking conditional generative adversarial network.

At step 108, the method includes selecting a subset of the plurality of synthetic neuromorphic samples based on at least one quality metric. The present disclosure includes multiple quality metrics which may be used alone or in any combination to select the synthetic neuromorphic samples. The quality metrics described herein are configured for use in neuromorphic sensing and for spiking neural networks. One advantage of neuromorphic processing is the energy efficient neuron-to-neuron communication. For example, Thus, quality metrics like sparsity and density can be configured to select synthetic neuromorphic samples. For example, Sparsity measures the average number of events per pixel over the duration of the sample whereas density refers to the average number of spikes within each frame at each timestep. These can be used to gauge the amount of information present in the spike train where more spikes indicate higher neural activity. Increasing this information, by lower neuron thresholds or raising light intensity, can improve model performance at the cost of energy consumption. Neurons with too high of a firing rate behave like their ANN counterparts which always output information.

The quality metrics can be used to determine the validity of the generated samples so that networks trained with the generated samples are accurate. Conventionally, validation is performed by a comparison of model performance on both the starting dataset and the synthetic dataset with the assumption that if models trained on each dataset have comparable accuracy, then the datasets are said to be comparable. While accuracy is a useful metric for ascertaining how similar two datasets are, it does not capture the spatiotemporal intricacies found within neuromorphic datasets which give them their energy efficiency. Therefore implementations of the present disclosure include additional and different quality metrics that can be used to validate the performance of synthetic neuromorphic samples for spiking neural network training that overcome the limitations of accuracy as a validation metric.

One example quality metric that can be used in some implementations is frame difference. Under ideal conditions, neuromorphic datasets encapsulate the individualized and asynchronous nature of neuromorphic sensors. However, simulating neuromorphic processing on conventional hardware requires events to be quantized into fixed-width time bins. For example, all events within a 1 ms window are compacted into a single binary value for that individual sensor. Depending on the simulation timestep, this quantization can inadvertently introduce a lock stepping effect where the asynchronous aspect of neuromorphic sensors blurs into a fully frame-based aspect, eliminating the desired energy efficiency. This can be detected by comparing the cosine similarity of successive pairs of quantized frames. Low similarity indicates low temporal redundancy whereas high overlap between frames indicates the sample is more similar to a static image than a neuromorphic sample.

Another example quality metric that can be used in some implementations is sparsity. Sparsity measures the average number of events per pixel over the duration of the sample. This can be used to gauge the activity of each pixel which approximates the amount of information present in the spike train. Increasing this information, for example by increasing the sensitivity of the neuromorphic sensor, can potentially improve model performance at the cost of energy consumption. As the events per pixel increases, the ability to encode spatiotemporal relations decreases until there is constant information in which case the processing neurons behave like their ANN counterparts.

Another example quality metric that can be used in some implementations is density. Related to sparsity and the energy efficiency of neuromorphic sensors, density refers to the average number of events within each frame at each timestep. This can be used to approximate the ad hoc relation between individual pixel sensors. In an ideal sensor, each pixel should operate independently and therefore capture minute changes in luminosity localized to that pixel. A high number of events per frame can indicate too low of a sensitivity and therefore all information is being propagated between frames increasing energy consumption.

Another example quality metric that can be used in some implementations is Optimal Transport Dataset Distance (OTDD). OTDD is a dataset distance metric which relies on the theory of mathematical transport to provide a model-agnostic comparison of datasets regardless of the distribution of labels. Pairwise datasets with low OTDD distance indicate high redundancy between the two datasets—the lack of many distinct samples which can distinguish between the two datasets. Applied to neuromorphic datasets, OTDD can be used at a high-level to indicate the richness of the dataset in terms of the degree of distinct spike trains present.

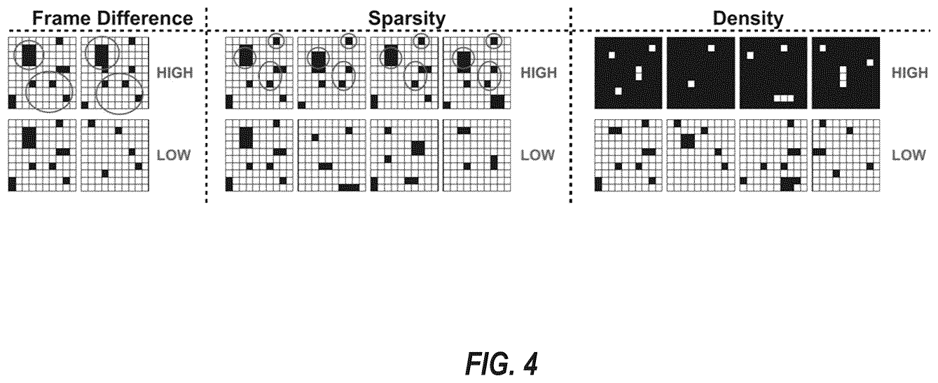

FIG. 4 illustrates a set of example quantized frames of spikes with corresponding example validation metrics. The high frame difference example shows high similarity between frames. The high sparsity example shows some pixels spiked during every timestep. The high density example shows almost all pixels spiked.

At step 110, the method includes training a spiking neural network using the subset of the plurality of synthetic neuromorphic samples. Optionally, the spiking neural network can be trained on both the subset of the synthetic neuromorphic samples and the neuromorphic dataset in combination.

With reference to FIG. 1B, implementations of the present disclosure include methods of using the SNN trained according to the method of FIG. 1A for inference to classify inputs from neuromorphic sensors. At step 152, the method includes receiving a neuromorphic sensor output from a neuromorphic sensor. The neuromorphic sensor can be any of the sensors described herein, including neuromorphic image sensors such as dynamic vision sensors and neuromorphic audio sensors.

At step 154, the method includes inputting the neuromorphic sensor output into the trained SNN classifier. The classifier can include a trained SNN classifier trained according to any of the methods described herein, for example with reference to FIG. 1A. The trained SNN classifier can optionally be run on an “edge” computing device or a remote computing device (e.g., a server). The SNN classifier can optionally include specialized hardware for accelerating the performance of SNNs.

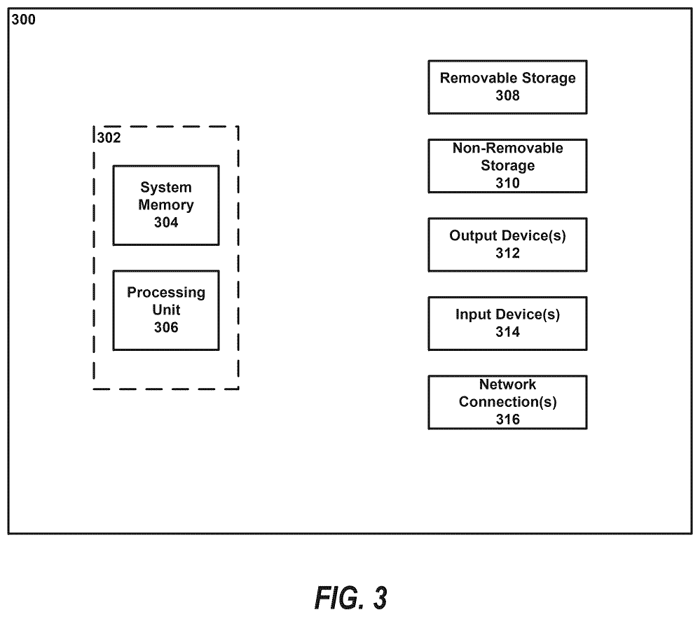

At step 156, the method includes receiving, from the trained SNN classifier, a classification of the neuromorphic sensor output. Optionally, the method can further include outputting the classification for display, for example by a computing device (e.g., the computing device 300 of FIG. 3).

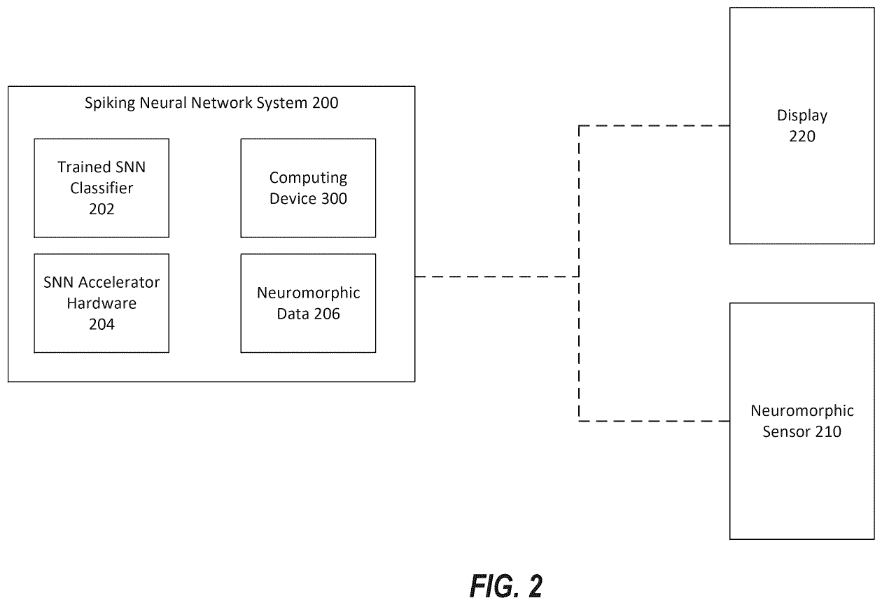

With reference to FIG. 2, an example system is shown according to implementations of the present disclosure. The example system includes a neuromorphic sensor 210, a neuromorphic computing system 200, and a display 220 in operative communication with one another through any combination of wired and/or wireless connections. The system of FIG. 2 can be configured to perform the methods described herein with reference to FIGS. 1A and 1B, for example.

The neuromorphic sensor 210 can be any of the neuromorphic sensors described herein (e.g., a dynamic vision sensor). The neuromorphic sensor 210 can capture any amount of neuromorphic data 206 that can be transmitted to and stored on a memory of the spiking neural network system.

The spiking neural network system can optionally include SNN accelerator hardware 204 (e.g., a neuromorphic processor) configured for efficient training and/or inference using a trained SNN classifier 202. The trained SNN classifier can optionally be stored in memory of the SNN accelerator hardware 204 and/or the computing device 300. Optionally, the spiking neural network system 200 is configured for training of the trained SNN classifier 202. Alternatively or additionally the spiking neural network system is configured to receive the trained SNN Classifier 202 from a remote computing device.

The spiking neural network system 200 can further include a conventional computing device 300, as shown in FIG. 3. The computing device 300 can be configured to control the SNN Accelerator hardware 204, and/or act as a network interface with the display 220 and/or neuromorphic sensor 210 as shown in FIG. 2.

The spiking neural network system 200 can be configured to input the neuromorphic data 206 into the trained SNN Classifier 202, and output the classification to the display 220. Alternatively or additionally, the classification can be stored in a memory of the spiking neural network system 200 or transmitted to a remote computing device (not shown). For example, the present disclosure contemplates that the spiking neural network system 200 can be configured to perform efficient edge computing to classify outputs of neuromorphic sensor(s)210 and transmit the classifications to remote computing devices. Because the neuromorphic sensor 210 outputs changes and not complete frames, the spiking neural network system can be a more efficient method of remote monitoring than conventional audio and visual monitors, which may, for example, continuously collect frames of audio or visual data that must each be analyzed by a neural network to classify them.

Studies were performed on example implementations of the present disclosure.

### Example 1

An example evaluated a dataset generation process disclosed herein on the DVSGesture dataset. DVSGesture is a neuromorphic dataset consisting of 29 subjects performing 11 different hand gestures under 5 different lighting types in front of a DVS camera. Samples were truncated to the first 1,450 ms, and 3 repetitions of all experiments were performed.

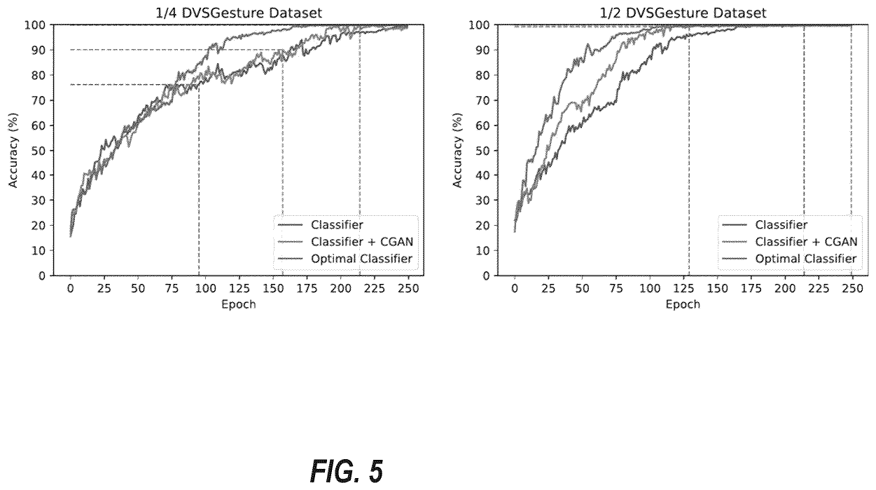

The study showed the positive impact on test accuracy progression of the dataset generation process disclosed herein. A spiking classifier was trained on ¼ and ½ subsets of the DVSGesture dataset to simulate data scarcity. These models were compared to optimal classifiers which had access to twice the amount of training data i.e., were trained on ½ and the entire DVSGesture dataset respectively. Both of these models were then compared to a classifier trained on both the starting subset as well as a synthetic dataset to illustrate the CGAN ability to stretch scarce datasets. The test accuracy progression, shown in FIG. 5, compares the effect of doubling a neuromorphic dataset with real data compared to with generated data. FIG. 5 illustrates a comparison of test accuracy progression using a subset of the DVSGesture dataset. The Classifier is trained using only the subset while the Classifier+CGAN utilizes both the subset and an equally sized synthetic dataset during training. The Optimal Classifier is trained using a subset that is doubled in size. Dotted lines indicate when the training would be halted per SPC, and better performance is shown by achieving higher accuracy at an earlier epoch.

The addition of generated samples to the training subsets resulted in higher model accuracy at earlier epochs indicating the generated samples were an appropriate substitute for situations with limited data. The optimal classifier, with access to additional data, did achieve a faster learning rate; however, the CGAN's ability to mimic a data distribution without requiring additional samples showed a noticeable improvement in both the rate at which the model learned as well as how long training lasted compared to the baseline classifier.

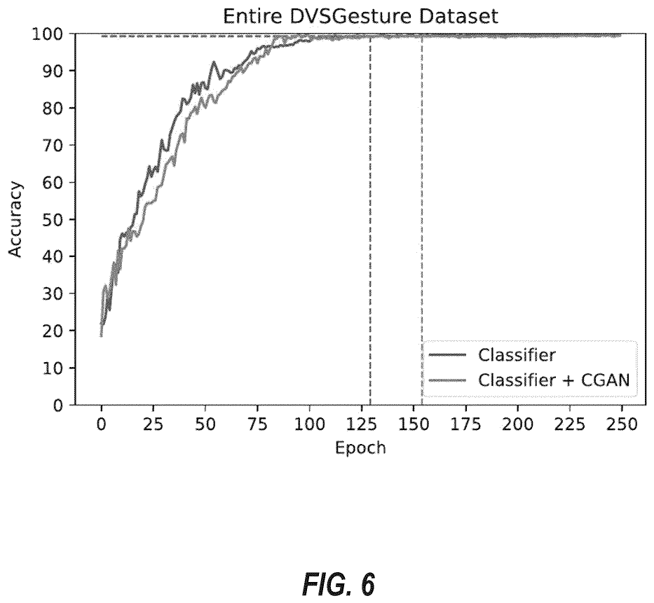

The study extended these accuracy experiments by looking at a classifier trained on the entire DVSGesture dataset compared to one trained with twice the number of samples, half being generated. Shown in FIG. 6, the addition of generated samples extended the viable training window, indicating that the generated samples were adding worthwhile information that benefited model training not found within the original DVSGesture dataset. However, the improvement compared to the previous 2 evaluations shows diminishing returns as the sizes of the datasets grow, a phenomenon explained in the Discussion section.

### Neuromorphic Quality Metrics

To further evaluate the example dataset generation process, the study examined the neuromorphic quality metrics described herein. Shown in Table 1 are the sample characteristics for the original DVSGesture dataset as well as the synthetic datasets generated from CGANs trained on ¼, ½, and the entire DVSGesture dataset.

TABLE 1
Neuromorphic quality metrics for the original DVSGesture dataset
and the generated datasets. Lower values for Sparsity and
Density indicate fewer spikes within the sample which correlate
to lower energy consumption during processing.

| | Frame | | |
|---|---|---|---|
| Dataset | Difference | Sparsity | Density |
| DVSGesture | 0.07105 | 0.00152 | 0.00152 |
| CGAN ¼ DVSGesture | 0.04033 | 0.00424 | 0.00424 |
| CGAN ½ DVSGesture | 0.00020 | 0.00030 | 0.00030 |
| CGAN Entire | 0.00010 | 0.00030 | 0.00030 |
| DVSGesture | | | |

The samples generated from the ¼ DVSGesture CGAN fall within an average 78.66% difference across the three metrics with a steep decline to 157.52% and 157.71% for the other CGAN models. While the metric values for the generated samples are not identical to those of the original DVSGesture dataset, this does not necessarily indicate that the generated samples are of inferior quality. Rather, this affirms that the generated samples exhibit a comparable dispersion of events found within neuromorphic datasets. Specifically, the sparsity and density metrics being within a degree of magnitude of the DVSGesture dataset indicate that the distribution of spikes throughout the 1,450 ms generated samples roughly approximates the same distribution of the original samples. Implemented on neuromorphic hardware, this would connote that the energy efficiency of both classifiers would be comparable.

### DISCUSSION

An interesting phenomenon occurred during the evaluation of the generative dataset process described herein. The addition of generated samples had a larger impact on test accuracy progression using ½ of the DVSGesture dataset compared to ¼ of the DVSGesture dataset. However, the neuromorphic quality metric scores significantly deviated for the same scenarios indicating a deviation in sample quality from the original dataset. This scenario highlights an important consideration for CGAN training and the types of samples generated.

Each of the 3 CGAN models, trained on ¼, ½, and the entire DVSGesture dataset respectively, were trained for the same number of epochs. Because of this, the later CGAN models had fewer training steps per sample and therefore ultimately learned the data distribution to a lesser extent. The effect of which was generated samples which more loosely emulated the characteristics of those found in the DVSGesture dataset and had far greater variation. This gave the classifier trained on the generated samples a wider view of the data distribution which allowed it to both outpace the other classifier and also train longer since the increased variation in samples introduced more variation in the training process. Ultimately, the generated samples still exhibited quality neuromorphic characteristics albeit with a greater variation than found in the original DVSGesture dataset.

The non-trivial nature of CGAN training combined with the spatiotemporal intricacies illustrate the importance of generating effective synthetic data. Generated samples need to be similar to their original counterparts and exhibit the same sparsity for energy-efficiency; however, they cannot be identical for then they would add no benefit during training. The balance of maintaining enough similarity for equivalent processing on neuromorphic hardware while also introducing variation to make the samples worthwhile for improving accuracy is a difficult task.

The example implementation used SLAYER 0.1 for SNN training within a Python 3.6.15 environment utilizing a PyTorch (Paszke et al., 2017) 1.7.1 underlying machine learning library. Model convergence was confirmed using Statistical Control Processes (SPC).

### Example 2

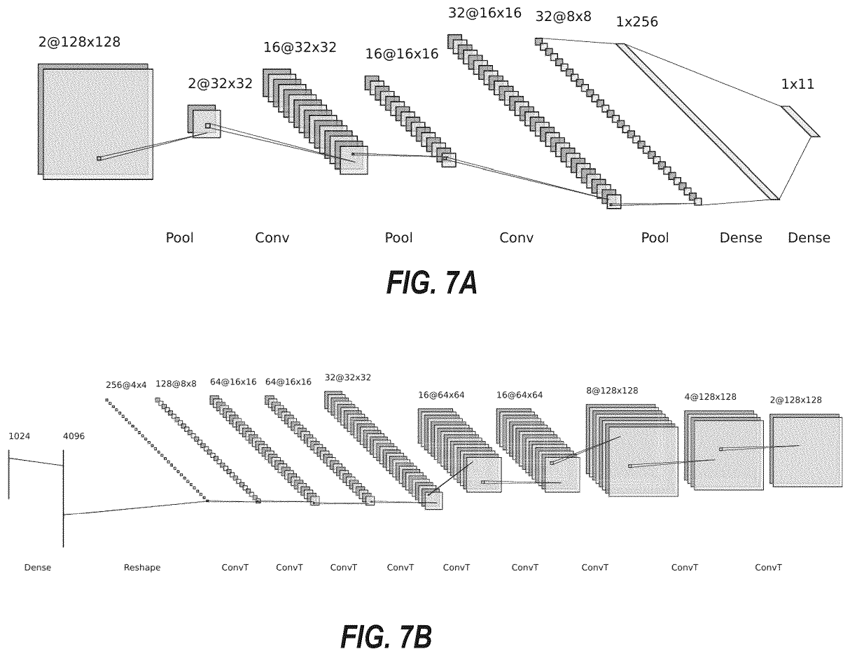

An additional study was performed on an example implementation of the present disclosure. The example implementation was implemented in Python 3.6.15 with PyTorch [34]1.7.1 serving as the underlying machine learning library. SLAYER 0.1 provided SNN training and was built from the public GitHub repository with neuron parameters shown in Table 2. The architecture of the example implementation is shown in FIGS. 7A and 7B.

| Neuron | Neuron |
|---|---|
| (Classifier) | (CGAN) |
| type: LOIHI | type: SRMALPHA |
| vDecay: 128 | theta: 10 |
| iDecay: 1024 | tauSr: 10.0 |
| refDelay: 1 | tauRef: 1.0 |
| wgtExp: 0 | scaleRef: 2 |
| tauRho: 1 | tauRho: 1 |
| scaleRho: 1 | scaleRho: 1 |

The study compared various evaluations of SNN classifiers on the DVSGesture dataset. DVSGesture is an event-based dataset consisting of 29 subjects performing 11 different hand gestures in front of a DVS camera. Each sample was collected under 5 lighting conditions: fluorescent, fluorescent-led, lab, led, and natural. Samples were truncated to the first 1,450 ms, and 3 repetitions of all experiments were performed with a train/test split of 80/20. The study evaluated model performance moving between the different lighting conditions during training and testing.

DVSGesture Spike Viewpoint Dependencies. The study first evaluated a baseline SNN classifier, trained on only a single lighting condition, across the entire spectrum of available lighting conditions. As shown in Table 1, model performance varies greatly depending on the train/test combination of lighting conditions with a 11.62% range in accuracy degradation. However, this range in accuracy degradation is not consistent across the 5 lighting conditions, as evident by the only 6.66% reduction when trained solely on the natural lighting condition. Clearly, there exists a deeper impact on model robustness which prevents a naive transfer of learning between the sample subjects under different lighting conditions. Further, the degree of separation between lighting conditions is not equal and therefore cannot be immediately deduced.

TABLE 1
SNN classifier accuracy based on training lighting conditions
(bold values are lighting with highest accuracy, underlined
values are classes expected to be highest per row).

| | TARGET | | | | |
|---|---|---|---|---|---|
| | | FLUO- | | | |
| | FLUO- | RESCENT | | | |
| START | RESCENT | LED | LAB | LED | NATURAL |
| FLUO- | 79.80 | 73.33 | 72.73 | 78.79 | 72.23 |
| RESCENT | | | | | |
| FLUO- | 80.30 | 83.03 | 78.79 | 77.78 | 86.36 |
| RESCENT | | | | | |
| LED | | | | | |
| LAB | 55.56 | 64.24 | 66.67 | 55.05 | 63.64 |
| LED | 69.70 | 76.97 | 74.75 | 76.26 | 76.52 |
| NATURAL | 74.24 | 79.39 | 72.73 | 78.28 | 78.79 |

Looking to the metrics, the study shows the unforeseen impact lighting has on spiking datasets. Table 2 captures the differences across the Frame Difference, Sparsity, and Density metrics. Respectively, these values fluctuate by 52%, 40%, and 40% indicating significant dissimilarity, even though all 5 lighting conditions capture the same 29 subjects and 11 hand gestures. These drastically different properties across the lighting conditions directly translate to differences in model performance. Due to the nature of the dynamics of spiking neurons, increasing or decreasing the distribution of spikes in time will alter the time and frequency of when a neuron will fire causing a chain-reaction of neurons spiking at different times.

TABLE 2
Metric calculations for DVSGesture based on lighting. Frame Difference
is the average cosine similarity between frames (timestep-to-
timestep), Sparsity is the average number of times each individual
pixel spikes over the presentation time, and Density is the
average number of pixels which spike per frame.

| | Frame | | |
|---|---|---|---|
| Lighting | Difference | Sparsity | Density |
| FLUO- | 0.069 | 0.0015 | 0.0015 |
| RESCENT | | | |
| FLUO- | 0.0662 | 0.0014 | 0.0014 |
| RESCENT | | | |
| LED | | | |
| LAB | 0.1008 | 0.0021 | 0.0021 |
| LED | 0.0592 | 0.0015 | 0.0015 |
| NATURAL | 0.06 | 0.0016 | 0.0016 |

TABLE 3
Optimal Transport Dataset Distance (OTDD) for the different
lighting conditions within the DVSGesture dataset.

| | | FLUO- | | | |
|---|---|---|---|---|---|
| | FLUO- | RESCENT | | | |
| | RESCENT | LED | LAB | LED | NATURAL |
| FLUO- | 0.03466 | 137,741.798 | 166,953.851 | 139,224.688 | 143,268.443 |
| RESCENT | | | | | |
| FLUO- | 137,741.798 | 0.03466 | 164,983.994 | 137,254.965 | 141,306.234 |
| RESCENT | | | | | |
| LED | | | | | |
| LAB | 166,953.851 | 164,983.994 | 0.03466 | 166,473.620 | 170,445.217 |
| LED | 139,224.688 | 137,254.965 | 166,473.620 | 0.03466 | 142,756.693 |
| NATURAL | 143,268.443 | 141,306.234 | 170,445.217 | 142,756.693 | 0.03466 |

Looking at the model-agnostic OTDD metric, found in Table 3, shows the massive geometrical distance between the lighting conditions. The correlations between accuracy fluctuations and geometrical distances shown in Table 4 solidify the intuitive relationship that more similar lighting conditions produce better accuracy within the same model while dissimilar lighting conditions lower accuracy. When unaccounted for, these differences between lighting conditions, what are referred to herein as spike viewpoint dependencies, within the model and are negatively impacting their generalization abilities.

TABLE 4
DVSGesture accuracy and OTDD correlation. Positive values indicate
a decrease in accuracy from the starting lighting condition with
an increase in OTDD while negative values indicate the opposite.
A larger magnitude of correlation indicates a larger change in
accuracy corresponding a larger OTDD difference.

| | | FLUO- | | | |
|---|---|---|---|---|---|
| | FLUO- | RESCENT | | | |
| | RESCENT | LED | LAB | LED | NATURAL |
| FLUO- | X | 1.109 | 1.000 | 0.171 | 1.165 |
| RESCENT | | | | | |
| FLUO- | 0.381 | X | 0.494 | 0.736 | −0.453 |
| RESCENT | | | | | |
| LED | | | | | |
| LAB | 0.976 | 0.216 | X | 1.024 | 0.261 |
| LED | 1.079 | −0.118 | 0.208 | X | −0.041 |
| NATURAL | 0.812 | −0.109 | 0.909 | 0.091 | X |

Helper Lighting. With the knowledge of the impact lighting has on model performance, the study evaluated accuracy degradation with SNN classifiers trained with helper lighting. Given a model trained on a starting lighting condition with a different target lighting condition, the study identified the “closest” and “furthest” candidate lighting conditions, based off OTDD, to be included during training. These results, shown in Table 5 and Table 6, showcase the discrepant impact a helper lighting can have during training. Counterintuitively, the addition of the target lighting condition during training did not result in the greatest accuracy improvement. Rather, the addition of either the closest or furthest candidate helper lighting conditions offered greater accuracy gains. Incorporating the furthest lighting condition into the training dataset resulted in the best performing model.

TABLE 5
Accuracy improvement for SNN classifier trained on a starting lighting condition with the addition
of either the target lighting condition, or the closest/furthest candidate lighting condition.

| | | TARGET | | | | |
|---|---|---|---|---|---|---|
| | HELPER | | FLUORESCENT | | | |
| START | LIGHTING | FLUORESCENT | LED | LAB | LED | NATURAL |
| FLUORESCENT | TARGET | 0.00 | 9.09 | 14.14 | 3.03 | 15.90 |
| FLUORESCENT | | 4.04 | 0.00 | 5.05 | 6.57 | 2.27 |
| LED | | | | | | |
| LAB + | | 27.77 | 20.61 | 0.00 | 26.26 | 28.79 |
| TARGET | | | | | | |
| LED | | 16.16 | 4.24 | 9.09 | 0.00 | 12.88 |
| NATURAL | | 14.14 | 6.06 | 10.10 | 5.05 | 0.00 |
| FLUORESCENT | +CLOSEST | 4.54 | 9.09 | 10.10 | 3.03 | 15.91 |
| FLUORESCENT | | 6.06 | −1.82 | 5.05 | 4.04 | −0.76 |
| LED | | | | | | |
| LAB | | 27.77 | 20.00 | 17.17 | 27.78 | 20.46 |
| LED | | 16.66 | 5.46 | 9.09 | 8.08 | 9.09 |
| NATURAL | | 12.12 | 3.64 | 7.07 | 4.55 | 9.85 |
| FLUORESCENT | +FURTHEST | 3.54 | 10.91 | 8.08 | 3.53 | 9.85 |
| FLUORESCENT | | 3.03 | 1.81 | 1.01 | 5.05 | −2.27 |
| LED | | | | | | |
| LAB | | 33.33 | 27.28 | 16.16 | 32.32 | 18.94 |
| LED | | 11.11 | 7.27 | 9.09 | 5.05 | 11.36 |
| NATURAL | | 14.65 | 12.12 | 8.08 | 9.09 | 13.63 |

TABLE 6
Average accuracy improvement, the increase in model accuracy
that each helper lighting contributed when moving away from
the START lighting condition to a different lighting condition.

| | Accuracy |
|---|---|
| Helper Lighting | Improvement (%) |
| START + TARGET | 9.65 |
| START + CLOSEST | 10.16 |
| START + FURTHEST | 10.96 |

### GAN Augmentation

To evaluate the example GAN augmentation process used in the study, a generative model was trained, solely on the samples from the starting lighting condition, to be used for creating additional samples. Therefore, it does not require any additional data but is instead refining the unused information already present in the starting dataset into usable samples. The study limited the number of generated samples to exactly double the size of the training dataset for an even comparison to the impact of the helper lighting conditions.

TABLE 7
Accuracy improvement for SNN classifier trained on a starting lighting condition
with the addition of augmented samples stemming from the generative model.

| | | TARGET | | | | |
|---|---|---|---|---|---|---|
| | HELPER | | FLUORESCENT | | | |
| ′ | LIGHTING | FLUORESCENT | LED | LAB | LED | NATURAL |
| FLUORESCENT | isoCGAN | 1.52 | 6.67 | 5.05 | 0.00 | 5.30 |
| FLUORESCENT LED | | 0.50 | 1.21 | 2.02 | 3.54 | −4.54 |
| LAB | | 6.59 | 10.30 | 9.09 | 8.08 | 6.06 |
| LED | | 3.53 | 0.00 | 0.00 | −2.02 | 6.06 |
| NATURAL | | 4.55 | 3.64 | 6.06 | −1.01 | 6.06 |
| FLUORESCENT | isoCGAN | 5.55 | 12.12 | 14.14 | 2.02 | 12.12 |
| | and Furthest | | | | | |
| FLUORESCENT LED | | 4.55 | 6.06 | 8.08 | 6.06 | 0.76 |
| LAB | | 29.29 | 27.88 | 15.15 | 29.80 | 28.03 |
| LED | | 5.55 | 5.45 | 7.07 | 0.50 | 12.12 |
| NATURAL | | 10.61 | 9.09 | 12.12 | 4.04 | 12.88 |

The performance impact the generated samples have on model robustness, found in Table 7, showcase that the addition of augmented samples is meaningful. While the 3.53% absolute improvement of the GAN approach is not as strong as that of the helper lighting methods, the isolated GAN does not require additional data collection and therefore removes the uncertainty for selecting which helper lighting to include during training. When looking at accuracy robustness, which is defined here as the ratio of accuracy change to the loss on the starting lighting condition found in Table 8, the study found that the GAN method has an 187.28% increase in accuracy robustness which was untapped by the original classifier.

TABLE 8
Average accuracy robustness, the ratio of model impact moving between
lighting conditions to the loss on the starting lighting condition.
Positive accuracy robustness indicates an improvement in accuracy
moving between lighting conditions while a negative accuracy robustness
represents a degradation in accuracy.

| | Accuracy |
|---|---|
| Approach | Robustness |
| START + TARGET | 0.4451 |
| START + CLOSEST | 0.4598 |
| START + FURTHEST | 0.5108 |
| START + isoCGAN | 0.1613 |
| START + isoCGAN + | 0.5165 |
| FURTHEST | |
| NOTHING | −0.1848 |

TABLE 9
SNN classifier accuracy based on combination
of training lighting conditions.

| | | TARGET | | | |
|---|---|---|---|---|---|
| | | FLUO- | | | |
| | FLUO- | RESCENT | | | |
| START | RESCENT | LED | LAB | LED | NATURAL |
| FLUO- | 84.34 | 82.43 | 82.83 | 81.82 | 80.30 |
| RESCENT | | | | | |
| LED | | | | | |
| FLUO- | 83.33 | 84.24 | 86.87 | 82.32 | 82.58 |
| RESCENT | | | | | |
| LAB | | | | | |
| FLUO- | 85.86 | 82.43 | 81.82 | 81.82 | 87.12 |
| RESCENT | | | | | |
| LED | | | | | |
| FLUO- | 88.38 | 88.48 | 80.81 | 84.85 | 88.63 |
| RESCENT | | | | | |
| NATURAL | | | | | |
| FLUO- | 83.33 | 84.85 | 83.84 | 82.83 | 84.09 |
| RESCENT | | | | | |
| LED LAB | | | | | |
| FLUO- | 86.36 | 81.21 | 83.84 | 84.34 | 85.61 |
| RESCENT | | | | | |
| LED LED | | | | | |
| FLUO- | 86.36 | 84.45 | 79.80 | 82.83 | 88.64 |
| RESCENT | | | | | |
| LED | | | | | |
| NATURAL | | | | | |
| LAB LED | 80.81 | 84.24 | 83.84 | 81.31 | 87.88 |
| LAB | 88.89 | 91.52 | 82.83 | 87.37 | 92.42 |
| NATURAL | | | | | |
| LED | 80.81 | 83.03 | 83.84 | 83.33 | 89.39 |
| NATURAL | | | | | |

Pairwise Comparisons. To further evaluate the GAN augmentation process, the study performed the same experiment with pairs of lighting conditions with the resulting performance shown in Table 9. The addition of an arbitrary lighting condition during training raised the average accuracy for moving to a different lighting condition by 10.67%. Like described previously, the study trained a generative model on the pair of lighting conditions and used the resulting samples to augment the training dataset for the downstream classifier. The results, shown in Table 10, show that the augmented samples further increasing model accuracy by 0.41%. An interesting outcome of this experiment emerged when looking at the fluorescent-natural pairwise model. In this scenario, the generative model's additional samples lowered model accuracy by an average 6.02%. The corollary to this is the single-lighting model's poor performance going between the fluorescent and natural lighting conditions. With instances of less-compatible pairs of lighting conditions, such as fluorescent and natural, the generative model can be producing a majority of samples between those two distributions with fewer samples outside that joint distribution.

TABLE 10
SNN classifier accuracy based on combination of training lighting
conditions with addition of augmented samples stemming from the
generative model trained on the pairs of lighting conditions.

| | | | | | | |
|---|---|---|---|---|---|---|
| | | | TARGET | | | |
| | HELPER | | FLUORESCENT | | | |
| START | LIGHTING | FLUORESCENT | LED | LAB | LED | NATURAL |

| | | | | | |
|---|---|---|---|---|---|
| FLUORESCENT | −2.52 | −0.61 | −4.04 | 0.00 | 1.52 |
| FLUORESCENT | | | | | |
| LED | | | | | |
| FLUORESCENT | 0.00 | 4.85 | −2.02 | 1.01 | 1.51 |
| LAB | | | | | |
| FLUORESCENT | 2.02 | 1.21 | 6.06 | 1.51 | 1.52 |
| LED | | | | | |
| FLUORESCENT | −8.08 | −4.84 | −5.05 | −7.58 | −4.54 |
| NATURAL | | | | | |
| FLUORESCENT | 4.55 | 2.42 | 4.04 | 3.53 | 0.00 |
| LED LAB | | | | | |
| FLUORESCENT | −3.03 | 2.43 | 1.01 | −2.52 | −3.79 |
| LED LED | | | | | |
| FLUORESCENT | 4.55 | 3.64 | 8.08 | 5.05 | 6.81 |
| LED NATURAL | | | | | |
| LAB | | | | | |
| LED | 4.04 | −0.60 | 1.01 | 0.21 | −3.79 |
| LAB | 0.50 | −6.07 | 2.02 | −4.04 | 3.03 |
| NATURAL | | | | | |
| LED | 1.01 | −1.21 | 7.07 | −3.03 | 1.52 |
| NATURAL | | | | | |

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for training a spiking neural network, the computer-implemented method comprising:
receiving a neuromorphic dataset;
training, using the neuromorphic dataset, a spiking conditional generative adversarial network to model a distribution of the neuromorphic dataset;
generating a plurality of synthetic neuromorphic samples by the trained spiking conditional generative adversarial network;
selecting a subset of the plurality of synthetic neuromorphic samples based on at least one quality metric; and
training a spiking neural network using the subset of the plurality of synthetic neuromorphic samples.

2. The computer-implemented method of claim 1, wherein the neuromorphic dataset comprises neuromorphic image data.

3. The computer-implemented method of claim 2, wherein the neuromorphic image data comprises a plurality of images corresponding to different lighting conditions.

4. The computer-implemented method of claim 1, wherein the quality metric comprises a similarity of the synthetic neuromorphic samples and the neuromorphic dataset.

5. The computer-implemented method of claim 1, wherein the quality metric comprises a frame difference metric.

6. The computer-implemented method of claim 5, wherein the frame difference metric comprises a cosine similarity of successive pairs of quantized frames.

7. The computer-implemented method of claim 1, wherein the quality metric comprises a sparsity metric.

8. The computer-implemented method of claim 7, wherein the sparsity metric comprises an average number of events per pixel of an image.

9. The computer-implemented method of claim 1, wherein the quality metric comprises a density metric.

10. The computer-implemented method of claim 9, wherein the density metric comprises an average number of events per frame.

11. The computer-implemented method of claim 1, wherein the spiking neural network is further trained on the neuromorphic dataset.

12. The computer-implemented method of claim 1, wherein the generative adversarial network is further trained on a source of latent noise.

13. A computer-implemented method comprising:
training a SNN classifier to obtain a trained SNN classifier, wherein the SNN classifier is trained by:
receiving a neuromorphic dataset;
training, using the neuromorphic dataset, a spiking conditional generative adversarial network to model a distribution of the neuromorphic dataset;
generating a plurality of synthetic neuromorphic samples by the trained spiking conditional generative adversarial network;
selecting a subset of the plurality of synthetic neuromorphic samples based on at least one quality metric; and
training a spiking neural network using the subset of the plurality of synthetic neuromorphic samples;
receiving a neuromorphic sensor output from a neuromorphic sensor;
inputting the neuromorphic sensor output into the trained SNN classifier; and
receiving, from the trained SNN classifier, a classification of the neuromorphic sensor output.

14. The computer-implemented method of claim 13, wherein the quality metric comprises at least one of a sparsity metric, a frame difference metric, or a similarity metric.

15. The computer-implemented method of claim 13, wherein the trained SNN classifier is further trained on the neuromorphic dataset.

16. The computer-implemented method of claim 13, further wherein the neuromorphic sensor output comprises a neuromorphic image captured by a dynamic vision sensor.

17. A system for image classification, the system comprising:
a dynamic vision sensor configured to acquire neuromorphic data;
a computing device operatively coupled with the dynamic vision sensor, the computing device comprising a processor and memory with instructions stored thereon, that, when executed by the processor, cause the processor to:
receive a trained SNN classifier, wherein the trained SNN classifier is trained using a synthetic neuromorphic dataset;
receive neuromorphic data from the dynamic vision sensor;
input the neuromorphic data into the trained SNN classifier; and
receive, from the trained SNN classifier, a classification of the neuromorphic data; and
output the classification.

18. The system of claim 17, wherein the SNN classifier is trained using a neuromorphic dataset and a plurality of synthetic neuromorphic samples generated by a CGAN.

19. The system of claim 17, wherein the processor is a neuromorphic processor.

20. The system of claim 17, wherein the processor is further configured to segment the neuromorphic data into a plurality of fixed-time-width bins.
